(19) United States
(12) Patent Application Publication
(10) Pub. No.: US 2012/0137024 A1
(43) Pub. Date: May 31, 2012

(54) DEVICE HAVING MULTI-FUNCTIONAL PERIPHERAL AND METHOD OF OPERATING THE SAME

(75) Inventors: Dong Hun KIM, Seoul (KR); Dong Kyun KIM, Seoul (KR); Tomohiro HARATA, Seoul (KR); Sung Hoon HONG, Seoul (KR); Hyok Su CHOI, Seoul (KR); Pil Won KIM, Seoul (KR)

(73) Assignee: SAMSUNG ELECTRONICS CO., LTD., Gyeonggi-Do (KR)

(21) Appl. No.: 13/303,311

(22) Filed: Nov. 23, 2011

(30) Foreign Application Priority Data
Nov. 26, 2010 (KR) 10-2010-0118608

(51) Int. Cl. G06F 3/00; G06F 13/24

(52) U.S. Cl. 710/8; 710/48

(57) ABSTRACT

A device including an attachable multi-functional peripheral device and a method of managing functions according to a connection between the device and the multi-functional peripheral device includes the steps of: checking a connected/disconnected state of the multi-functional peripheral device and an open/closed state of the folding device when a preset interrupt is generated; and controlling a functional operation related the preset interrupt according to the connected or disconnected state of the multi-functional peripheral device and the open or closed state of the folding device.

### CLAIM OF PRIORITY

This application claims, pursuant to 35 USC 119, priority to, and the benefit of the earlier filing date of, that patent application entitled “Device Having Multi-Functional Peripheral and Method of Operating the Same,” filed on Nov. 26, 2010 in the Korean Intellectual Property Office, and afforded serial number 10-2010-0118608, the contents of which are incorporated by reference, herein.

### BACKGROUND OF THE INVENTION

1. Field of the Invention

The present invention relates to the field of portable devices, and more specifically to a device having a multi-functional device attachment and a method of operating the portable device considering a state of the multi-functional device.

2. Description of the Related Art

With the significant development of information, communication and semiconductor technologies and their contribution to the supply of portable terminals, the use of portable terminals has rapidly increased. Technologies incorporated into the latest mobile (portable) terminals allow these terminals to expand into fields that are not typically inherent to the mobile terminal. Rather mobile technology convergence has allowed the current mobile terminal to embrace many fields that were typically left to discrete components or other types of devices. For example, mobile communication terminals, in addition to their inherent communication function (e.g., voice call and message transmission), now include technologies that allow for functions, such as a TV viewing, (i.e., mobile broadcasting such as digital multimedia broadcasting (DMB) and digital video broadcasting (DVB)), a music reproducing (MPEG audio Layer-3 (MP3)), photographing (still and video camera), and many different types of network (.e.g., internet) access, etc.

The current mobile terminal may also include a near field wireless communication device (e.g., a Bluetooth communication device, an Infrared ray communication device, etc.) There are several applications for using the near field wireless communication device such as using an external handset (an earphone/microphone), or streaming music (audio) data to the external headphone. Moreover, in order to improve mobility and convenience of the mobile terminal, there is a suggested technology of separating some components of the mobile terminal and of connecting the separated components through the near field wireless communication device.

Thus, in the mobile terminal having a separated peripheral environment the convenience of mounting and attaching the peripheral devices, the portability of the individual peripheral devices, and improvement of operability of the mobile terminal interlinked with the separated peripheral devices are issues that must be considered and addressed.

Thus, realizing a structure of for the convenient attachment, portability, and operability of peripheral devices to a mobile terminal is of high importance.

### SUMMARY OF THE INVENTION

The present invention has been made in view of the above problem(s), and the present invention provides a device having an attachable multi-functional peripheral device and a method of operating the same.

The present invention also provides a folding device including a multi-functional peripheral device attachable to a hinge of the folding device and a method of operating the same.

The present invention also provides a folding device including a multi-functional peripheral device attachable to a hinge of the folding device and a method of controlling behavior between the multi-functional peripheral device and the folding device by interlinking the multi-functional peripheral device and the folding device.

The present invention also provides a folding device for including a multi-functional peripheral device attachable to a hinge of the folding device and for realizing an environment for the operation of the folding device according to whether the multi-functional peripheral device is attached or not attached to improve use and convenience of the folding device and a method of operating the apparatus.

In accordance with the aspects of the present invention, there is provided a method of operating a folding device including an attachable multi-functional peripheral device, the method including the steps of: checking a connected/disconnected state of the multi-functional peripheral device and an open/closed state of the folding device when a preset interrupt is generated; and controlling a functional operation related the preset interrupt according to the connected or disconnected state of the multi-functional peripheral device and the open or closed state of the folding device.

In accordance with the aspects of the present invention, there is provided a computer-readable recording medium on which a program for executing the above-mentioned method in a processor.

In accordance with the aspects of the present invention, there is provided a folding device including an attachable multi-functional peripheral device, the folding device including: a first connection unit connected to a second connection unit of the multi-functional peripheral device; and a controller controlling charging of the multi-functional peripheral device according to a given condition when the first connection unit is connected to the second connection unit of the multi-functional peripheral device and wireless connection with the multi-functional peripheral device when the first connection unit is disconnected from the second connection unit of the multi-functional peripheral device.

In accordance with the aspects of the present invention, there is provided a device comprising a multi-functional peripheral device, and a folding device: supporting an attachable hinge of the multi-functional peripheral device, wherein the multi-functional peripheral device is removably attachable to the attachable hinge; performing charging of the multi-functional peripheral device when the multi-functional peripheral device is in a connected state to the folding device through the attachable hinge, and performing wireless connection of the multi-functional peripheral device when the multi-functional peripheral device is in a disconnected state.

In another aspect of the invention, a portable terminal is disclosed that comprises a first display element enclosed within a first enclosure; a second enclosure, opposing the first enclosure, and a hinge joining said first and second enclosures partially along an edge of each of the first and second enclosures, the hinge further comprising an electrical connection for removably connecting a peripheral device along the edge of the first and second enclosures, and a processor in communication with a memory, the memory including code which when accessed by the processor causes the processor to: determine whether the peripheral device is connected to the electrical connector; determine whether the first and second enclosures are in one of: an open and closed state; and perform at least one operation based on whether the first and second enclosure are in one of: an open and a closed state, and whether the peripheral device is connected to the electrical connector along the edge of the first and second enclosure.

Hereinabove, the features and advantages of the present invention are described in a relatively broad perspective to help those skilled in the art in understanding the present invention. Other features and advantages constituting the subject matter of the present invention will be more apparent from the following detailed description.

Accordingly, the device having a multi-functional peripheral device according to the present invention provides for the multi-functional peripheral device being attached to a hinge of the device so that portability may be improved and that the possibility of the peripheral device being lost is significantly reduced. Moreover, according to the present invention, the multi-functional peripheral device may be used in various fashions so that a user's use of the device may be easier and/or more convenient according to the status that the multi-functional peripheral device has with regard to it being separated from or connected to the device.

According to the present invention, when the multi-functional peripheral device is connected through a hinge of the device, a charging function may be provided by the device so that a charging process for the multi-functional peripheral device may be omitted. In addition, when the multi-functional peripheral device is connected to the device, various events generated from the device may be forwarded and controlled. For example, the multi-functional peripheral device may be set to serve as a sub-display unit so that information regarding events, such as reception of SNS (Social Networking Service) generated from the device, reception of RSS, (Rich Site Summary) and media reproduction may be displayed and that the displayed information may be confirmed or controlled.

Moreover, according to the present invention, when the multi-functional peripheral device is separated from the device, forwarding and control of various events that are generated from the device may be supported. For example, the multi-functional peripheral device may be set to serve as a sub-display unit so that information on events such as reception of SNS generated from the device, reception of RSS, and media reproduction may be displayed and that the displayed information may be confirmed or controlled. In addition, the multi-functional peripheral device is set to serve as a remote controller so that reproduction of media may be remotely controlled. When the multi-functional peripheral device is operated as a headset audio may be outputted during playing a media file or the sound source may be transmitted and received for vocal/video communications.

The present invention is preferably implemented in a hinge of a device (hereinafter referred to as a parent device). According to the present invention, the multi-functional peripheral device is attached to and detached from the hinge of the device and thus the device and the multi-functional peripheral device may be operated in various fashions so that use, convenience, stability, and competitiveness of the parent device and the multi-functional peripheral device can be improved.

### BRIEF DESCRIPTION OF THE DRAWINGS

The above features and advantages of the present invention will be more apparent from the following detailed description in conjunction with the accompanying drawings, in which:

FIGS. 1 to 3 illustrate a multi-functional peripheral device attached to and detached from a parent device according to an exemplary embodiment of the present invention;

FIGS. 4 and 5 illustrate a multi-functional peripheral device according to an exemplary embodiment of the present invention and operation thereof;

FIG. 6 is a schematic block diagram illustrating a device according to an exemplary embodiment of the present invention;

FIG. 7 is a view schematically illustrating a charging operation between a parent device and a multi-functional peripheral device according to an exemplary embodiment of the present invention;

FIGS. 8 and 9 illustrate event processing between a device and a multi-functional peripheral device according to an exemplary embodiment of the present invention;

FIG. 10 is a flowchart illustrating a method of charging a multi-functional peripheral device by a parent device according to an exemplary embodiment of the present invention;

FIG. 11 illustrates an operation managed by interconnection between a parent device and a multi-functional peripheral device according to an exemplary embodiment of the present invention; and

FIG. 12 is a flowchart illustrating a method for managing attachment and detachment of a multi-functional peripheral device to and from a parent device according to an exemplary embodiment of the present invention.

### DETAILED DESCRIPTION OF THE INVENTION

Exemplary embodiments of the present invention are described in detail with reference to the accompanying drawings. The same reference symbols are used throughout the drawings to refer to the same or like parts. For the purposes of clarity and simplicity, detailed descriptions of well-known functions and structures incorporated herein may be omitted to avoid obscuring the subject matter of the present invention. That is, detailed descriptions of constructions or processes known in the art may be omitted to avoid obscuring the invention in unnecessary detail.

The present invention relates to a parent device having a multi-functional peripheral (MFP) device to it and a method of managing the same. In exemplary embodiments of the present invention, the parent device includes a folding device having a hinge and the MFP device may be removably attachable to the device. According to the present invention, various managements of the MFP device may be achieved in accordance with the attachment and detachment of the MFP device. For example, charging the MFP device, serving the MFP device as a sub-display unit, serving the MFP device as a remote controller, and serving the MFP device as a wireless headset may be available dependent upon the operating characteristics of the MFP device.

In the exemplary embodiments of the present invention, the MFP device is attached to, or detached from, a folding device, may support wire data communication by wired connection with the folding device when the MFP device is attached and radio data communication via wireless line when the MFP device is detached from the folding device. The MFP device may support various functions in association with a managing method such as displaying on a screen, outputting of audio, remote control, transmission and reception of voice data, etc. in the connected state.

In exemplary embodiments of the present invention, terms, a parent device, a folding device, a multi-functional peripheral device (or MFP device), a headset, and a remote controller are defined for the purpose of illustration. Hereinafter, terms such as a folding device and a multi-functional peripheral device are used throughout this application but the present invention is not limited thereto.

That is, the configuration and operation controlling method of a folding device according to an exemplary embodiment of the present invention will be described in detail with reference to the accompanying drawings. However, the configuration and the operation controlling method of the folding device are neither limited nor restricted by the following description and may be applied to various exemplary embodiments.

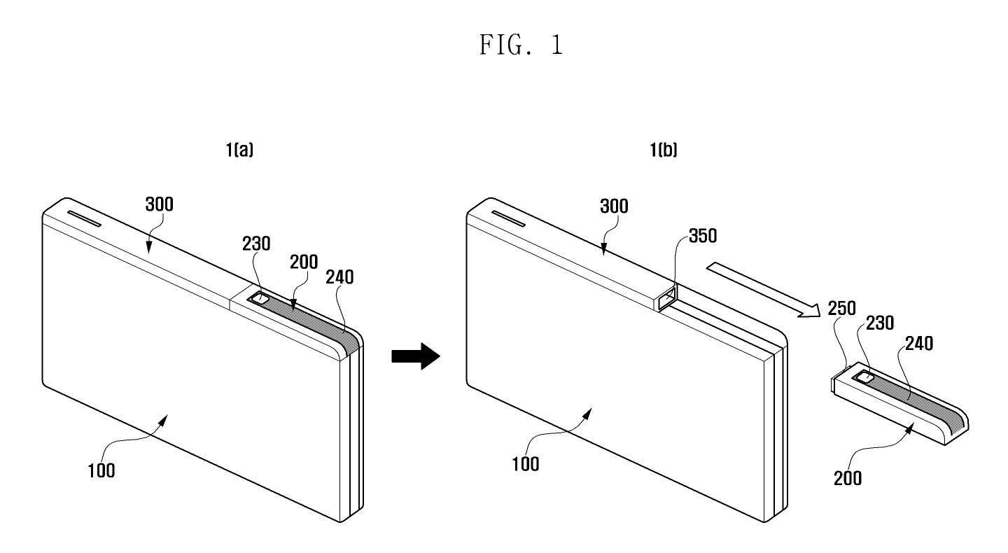

FIGS. 1 to 3 are views illustrating a multi-functional peripheral device attached to, and detached from, a folding device (i.e., parent device) according to an exemplary embodiment of the present invention.

FIG. 1 shows a multi-functional peripheral device 200 attached to (illustration 1a) or detached from (illustration 1b) a folding device 100 in a closed state. With reference to illustration 1(a), when the multi-functional peripheral device 200 is attached to the folding device (i.e., parent device) 100, the multi-functional peripheral device 200 is sized to provide for a contoured fit with the body of folding device 100. The multi-functional peripheral device 200, in this illustrated case, is attached in the position of the hinge assembly of the folding device 100. With reference to illustration 1(b) the multi-functional peripheral device 200 is shown detached from the folding device 100. In this case, the multi-functional peripheral device 200 detaches from the folding device 100 by sliding the multi-functional peripheral device 200 in the direction of the illustrated arrow. It would be recognized that to attach the multi-functional peripheral device 200, then the multi-functional peripheral device 200 may be slide in a direction opposite than the illustrated arrow. Although not shown, it would be recognized that the folding device 100 includes engagement means that support the multi-functional peripheral device 200 when the multi-functional peripheral device 200 is slide into position. Also shown is connection 350 in which an end connect 250 of the multi-functional peripheral device 200 engages, when the multi-functional peripheral device 200 is slide into the position shown in illustration 1a.

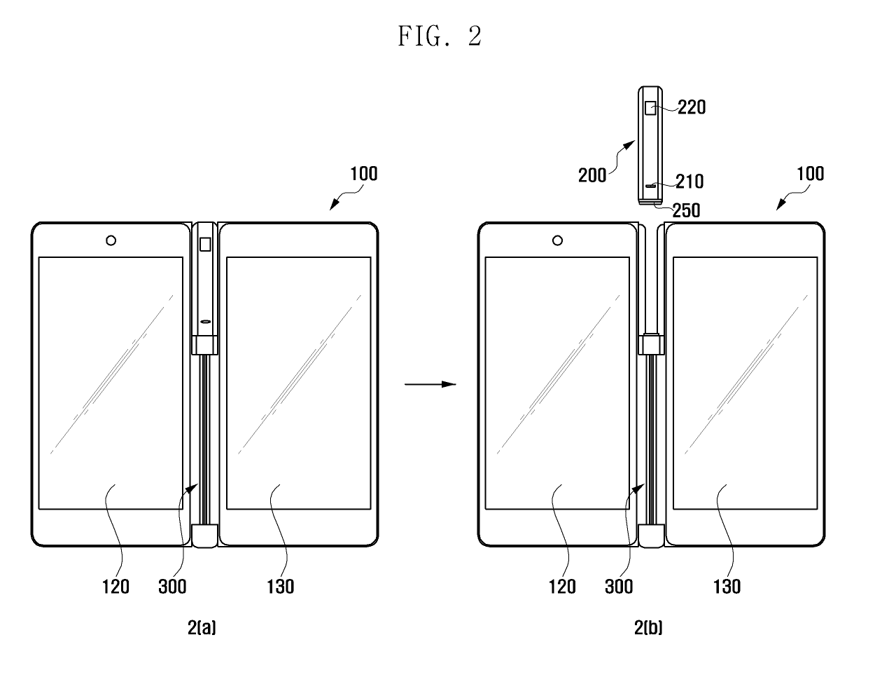

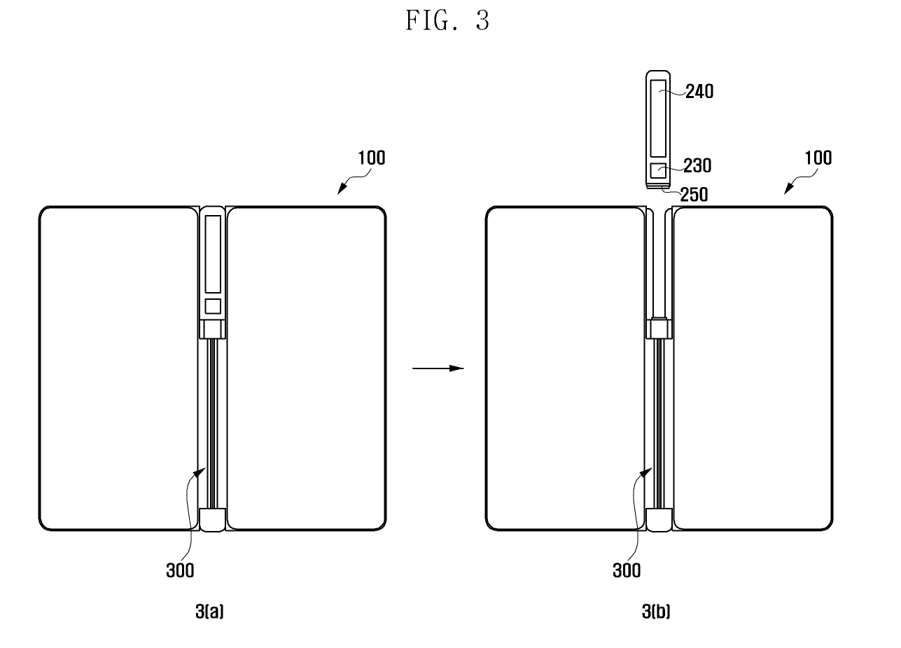

FIG. 2 shows the multi-functional peripheral device 200 attached to (illustration 2a) and detached from (illustration 2b)) the folding device 100, wherein the folding device 100 is in an open state. FIG. 2 shows the inside of the folding device 100 when in the open state. FIG. 3 shows the multi-functional peripheral device 200 attached to (illustration 3a) and detached from (illustration 3b) the folding device 100 in a manner similar to FIG. 2. FIG. 3 shows the outside of the folding device 100 in the open state.

Referring to FIGS. 1 to 3, the multi-functional peripheral device 200 is coupled with (i.e., attached to) hinge 300 element of the folding device 100. Thus, the hinge 300 of the folding device 100 and the multi-functional peripheral device 200 include a coupling device for the mechanical coupling of the multi-functional peripheral device 200 with hinge 300 and the folding device 100. That is, the hinge 300 of the folding device 100 includes a first connection unit 350 that couples with the multi-functional peripheral device 200 and the multi-functional peripheral device 200 includes a second connection unit 250 that couples with the first connection unit 350 of folding device 100. In the exemplary embodiments of the present invention, the first connection unit 350 and the second connection unit 250 are connecting interfaces and each may include s receptacle (or a female connector) and a plug (or a male connector). For example, when the first connection unit 350 is a shown as a receptacle (female element) and the second connection unit 250 is shown as a plug (male element). On the other hand, when the first connection unit 350 may be a plug, the second connection unit 250 may be a receptacle unit.

Moreover, in the exemplary embodiments of the present invention, the first connection unit 350 and the second connection unit 250 may include one or more electrically connectable sockets and pins that may be used recognizing the multi-functional peripheral device 200. The connection between the first connection unit 350 and the second connection unit 250 may also provide for charging the multi-functional peripheral device 200 from a power source incorporated within the folding device 100. For example, when the first connection unit 350 is a receptacle and the second connection unit 250 is a plug, the first connection unit 350 may be female pins (sockets) to accommodate a plurality of pins and the second connection unit 250 may be a plurality of pins that correspond to the sockets within the first connection unit 350. The pins may include a first pin for recognizing the attachment or detachment of the multi-functional peripheral device 200 with the folding device 100. That is, a connecting state of the folding device 100. Similarly, a second pin may be used for charging the multi-functional peripheral device 200 attached to the folding device 100 by supplying electric power, and a third pin for data communication between the folding device 100 and the attached multi-functional peripheral device 200. In one exemplary embodiment of the invention, the connection units 250 and 350 may represent a Universal Serial Bus (USB) or mini-USB connection. Universal Serial Bus connections are well known in the art and need not be disclosed in detail herein.

The multi-functional peripheral device 200 may include a microphone 210 (FIG. 2), a speaker 220 (FIG. 2), a button 230 (FIG. 1), and a display unit 240 (FIG. 1). The multi-functional peripheral device 200, as illustrated in FIG. 2, may include the microphone 210 and the speaker 220 provided on one side and as shown in FIG. 3, the button 230 and the display unit 240 provided on the other side.

The folding device 100 typically includes two bodies coupled with each other by the hinge 300 and may include a first display unit 120 and a second display unit 130 provided on the inner surfaces of the bodies.

Although not depicted in FIGS. 1 to 3, the folding device 100 and the multi-functional peripheral device 200 may include a communication module (not shown) to support radio communication between the folding device 100 and the multi-functional peripheral device 200 when the multi-functional peripheral device 200 is detached from the folding device 100. For example, each of the folding device 100 and the multi-functional peripheral device 200 may include a near field communication module (not shown) for supporting near wireless communication. For example, each device may include a communication system such as a Bluetooth communication, and/or an infrared communication, etc., that supports wireless communication via automatic connection through the communication module when the multi-functional peripheral device 200 is detached from the folding device 100.

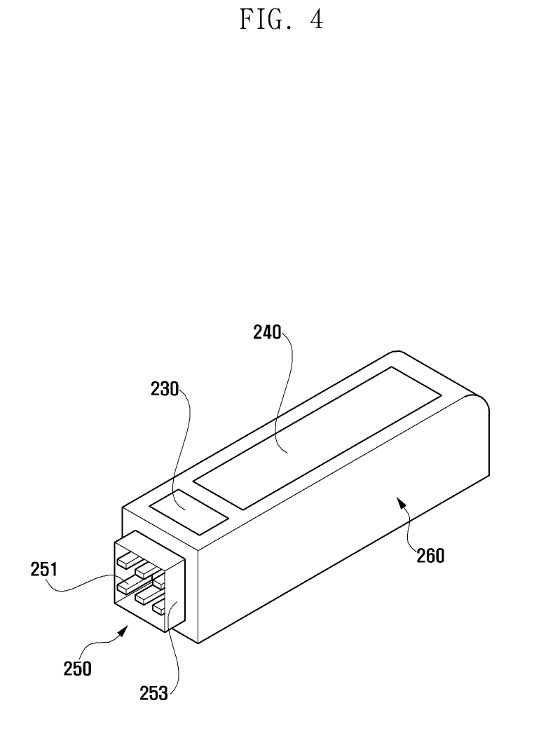

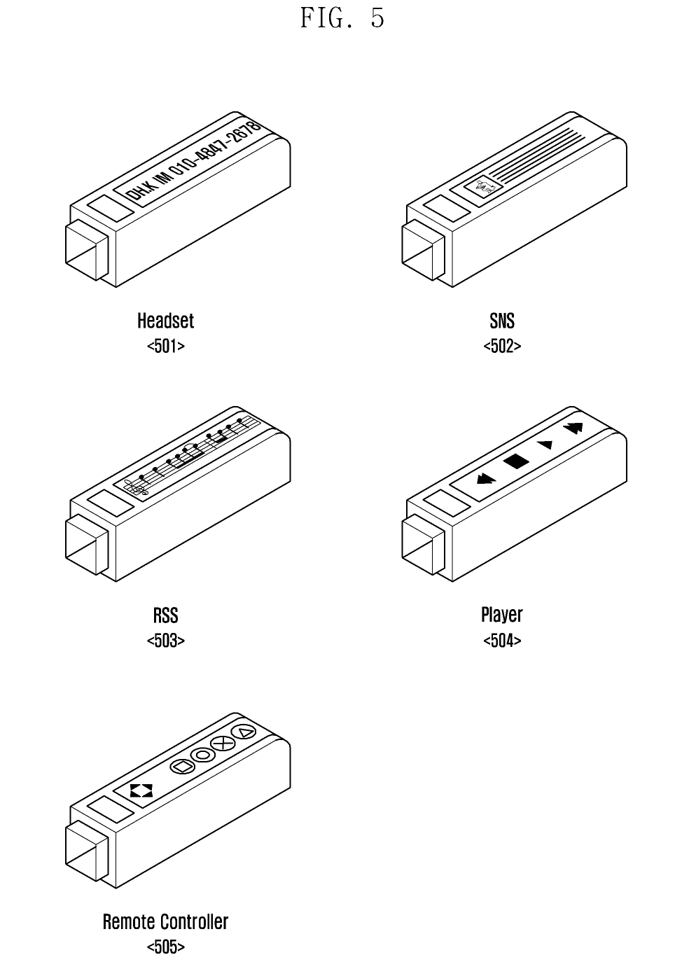

FIGS. 4 and 5 represent prospective views of multi-functional peripheral device 200 according to an exemplary embodiment of the present invention, wherein FIG. 4 shows an example of the multi-functional peripheral device 200 and FIG. 5 shows exemplary operational examples of the multi-functional peripheral device 200. Referring to FIG. 4, the multi-functional peripheral device 200 may be divided into a body 260 and the second connection unit 250. The body 260 may include a preset button 230 and a display unit 240 provided on a first side and the microphone 210 and the speaker 220 provided on a second side (not shown). The display unit 240 of the multi-functional peripheral device 200 may be implemented by an interface supporting a touch-based input (for example, a touch screen) and the button 230 may be omitted.

In addition, the connection unit 250 is shown including a plurality of electrically connectable pins 251 surrounded by a collar 253. The collar 253 represents a means for engaging and retaining connection to the first connection unit 350 (FIG. 1).

FIG. 5 shows examples of operation of the multi-functional peripheral device 200 are illustrated.

As indicated by reference numerals 501 to 505, the multi-functional peripheral device 200 may output various types of information that is fed back from the folding device 100, when the multi-functional peripheral device 200 is mounted to or detached from the hinge of the folding device 100.

For example, the multi-functional peripheral device 200 may display caller information on a received call, as indicated by numeral 501, according to a call function of the folding device 100, information such as real time messages received through a Social Networking Service (SNS), such as Facebook, Tweeter, Metoday, and the like may be displayed as indicated by reference numeral 502, information such as weather information, news information, securities information, etc., received by Rich Site Summary (RSS) service may be displayed as indicated by reference numeral 503, information regarding music data and a music reproducing function (e.g., a control item for controlling a function in connection with reproduction) may be displayed as indicated by reference numeral 504, or information regarding a game function, a moving picture reproduction, and remote control for executed application, (e.g., a control item for the remote control) may be displayed as indicated by reference numeral 505. In addition, the multi-functional peripheral device 200 may output information such as Short Message Service (SMS), Multimedia Message Service (MMS), e-mail, e-book, and the like that are fed back and may display information for controlling function of these services or operations.

When the multi-functional peripheral device 200, as indicated by reference numeral 501, is detached from the folding device 100 and serves as a headset or when the multi-functional peripheral device 200 is attached to the folding device 100, the multi-functional peripheral device 200 may serve as a display unit providing information regarding a received call. As indicated by reference numerals 502 and 503, when the multi-functional peripheral device 200 is attached to, or detached from, the folding device 100, the multi-functional peripheral device 200 may serve as a display unit presenting information regarding received information. In the case indicated by reference numerals 504 and 505, when the multi-functional peripheral device 200 is attached to, or detached from, the folding device 100, the multi-functional peripheral device 200 may operate as a remote control for a remote control function and as a display unit outputting information regarding the remote control.

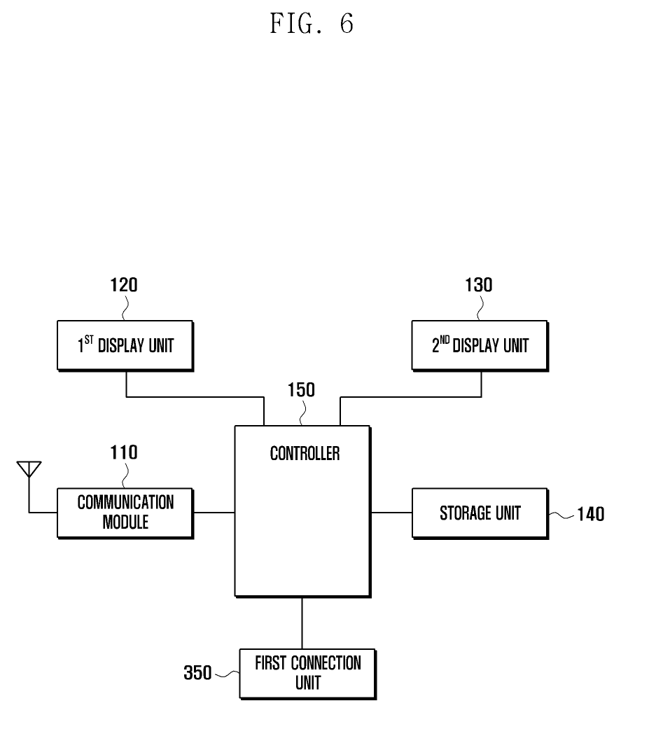

FIG. 6 is a schematic block diagram illustrating the folding device 100 according to the exemplary embodiment of the present invention. Referring to FIG. 6, the folding device 100 includes a communication module 110, a first display unit 120, a second display unit 130, a storage unit 140, a first connection unit 350, and a controller 150. In addition, the folding device 100 may further include an audio processor having a microphone and a speaker, a digital broadcasting module receiving and reproducing digital broadcasting such as mobile broadcasting (for example, digital multimedia broadcasting (DMB) and digital video broadcasting (DVB)), a camera module for photographing still and a moving pictures, at least one communication module supporting a mobile communication-based mobile communication service and wireless local area network (WLAN) based internet service, a touch pad for touch-based input, and a function for physical key input. Each of the aforementioned items and functions are well known in the portable terminal art and need not be described in detail herein. For example, Samsung Fascnation and Samsung Galaxy Tab are examples of well-known portable terminals that incorporate the aforementioned features. Samsung, Samsung Fascnation and Samsung Galaxy Tab are registered Trademarks of Samsung Electrons Co., Ltd., a corporation of the Republic of Korea.

The communication module 110 supports near field communication function. For example, when the multi-functional peripheral device 200 is separated from the folding device 100, the communication module 110 may perform communication based on the near field communication with the multi-functional peripheral device 200 under the control of the controller 150. For example, the communication module 110 may be a Bluetooth communication module supporting Bluetooth communication function. In this case, when the multi-functional peripheral device 200 is separated from the folding device 100, the communication module 110 may process reception and transmission of information for automatic connection by auto pairing under the control of the controller 150. When the communication module 110 is connected to the multi-functional peripheral device 200 via a wireless connection based on the near field communication protocol, the communication module 110 may process data transmission and reception to and from the multi-functional peripheral device 200.

The first display unit 120 and the second display unit 130 provide screen displays of the folding device 100. In one embodiment, one screen may represent a home screen while the other screen may represent an execution screen of applications supported by the folding device 100. For example, the first and second display units 120 and 130 may provide execution screens for a message function, an e-mail function, an internet function, a multimedia function, a search function, a communication function, an e-book reading function (e-book function), a function of photographing was a still camera mode or a moving picture camera mode, a still picture/moving picture reproducing function, a TV function (for example, a function of reproducing a mobile broadcasting such as DMB, DVB, etc.), a music reproducing function (e.g., an MP3 reproducing function), a widget function, a memo function, and a game function. In one aspect of the invention, liquid crystal displays (LCD) are used as the first display unit 120 and the second display unit 130. However, it would be understood that other types of displays employing different types of technologies (e.g., organic light emitting diode (OLED), an active matrix OLED (AMOLED)) may be also used as the first display unit 120 and the second display unit 130 without altering the scope of the invention.

The first display unit 120 and the second display unit 130 may provide a landscape screen mode or a portrait screen mode according to a rotation direction of the folding device 100 (or the direction to which the folding device 100 is presented) for displaying application execution screens as described above.

In an exemplary embodiment, the first display unit 120 and the second display unit 130 may include interfaces supporting a touch-based input. For example, the first display unit 120 and the second display unit 130 may support a touch-based user input through a touch screen and may generate an input signal corresponding to the user input to transmit the generated signal to controller 150. In an exemplary embodiment, although the first display unit 120 and the second display unit 130 are provided, the present invention is not limited thereto. That is, the folding device 100 may include only one of the first display unit 120 and the second display unit 130 as a display unit and another type of input device (for example, a physical buttons associated with a keypad) may be provided on the other side thereof.

The storage unit 140 stores various programs and data that are executed and processed by the folding device 100 and may include at least one volatile memory (RAM) and a non-volatile memory (ROM, FLASH). The storage unit 140 may store an operating system of the folding device 100, programs and data related to operation of the first display unit 120 and the second display unit 130, programs and data related to input control using the first display unit 120 and/or the second display unit 130, programs and data related to charging of the multi-functional peripheral device 200 connected to the folding device 100 through the first connection unit 350, and programs and data related to functions corresponding to the attachment and detachment of the multi-functional peripheral device 200 continuously or instantly. The storage unit 140 may store messages that are received and transmitted when SNS, such as TWEETER, FACEBOOK, and the like, a message service, such as SMS, MMS, and an e-mail service, and a messenger service, are used. The storage unit 140 may store a critical value associated with checking battery capacity of the folding device 100, related to the charging of the multi-functional peripheral device 200. The operation using the critical value will be described later. The programs and data may be stored in a program area (not shown) and a corresponding data area (not shown). The program area and the data area may be accessed by controller 150 to execute the functions associated with the stored programs.

The first connection unit 350, as described above, is an interface for the connection with the multi-functional peripheral device 200 to the parent device 100. The first connection unit 350 may be connected to the second connection unit 250 of the multi-functional peripheral device 200 at an end, wherein connection to the controller 150 and a power supply (not shown) supplying electric power from a battery may be made. The connection between the first connection unit 350 and the power supply may be turned on/off by the controller 150. The turning on/off of the connection between the devices 100 and 200 will be described later.

The controller 150 controls overall operation of the folding device 100. The controller 150 may control operations related to functional management through the connection between the folding device 100 and the multi-functional peripheral device 200. For example, the controller 150 may check whether the multi-functional peripheral device 200 is connected (attached) to or disconnected (detached) from the folding device 100 by checking whether an electrical connection between the first connection unit 350 and the second connection unit 250 is made. For example, an electrical connection (physical) may be deemed to be made when a voltage on a corresponding pin is high or low.

The controller 150 may control data communication between the multi-functional peripheral device 200 and the folding device 100 when the multi-functional peripheral device 200 is connected to the folding device 100. The controller 150 may check a given condition when the multi-functional peripheral device 200 is connected to the folding device 100 and may control supplying of electric power to the folding device for the charging of the multi-functional peripheral device 200. In this case, the controller 150 may control the supplying, or interrupting of, electric power through a switching control between the first connection unit 350 and the power supply. When the multi-functional peripheral device 200 is detached from the folding device 100, the controller 150 may control the wireless communication through an automatic connection protocol. For example, the Bluetooth protocol uses a well-known auto-pairing feature.

In one case, a preset interrupt may be generated, in which the controller 150, upon receiving the interrupt, may control a function corresponding to the interrupt by considering the connected/disconnected state of the multi-functional peripheral device 200 and an open/closed state of the folding device 100. These controlling operations of the controller 150 will be described with regard to different operations of the folding device 100 and a method of controlling the same.

Otherwise, the controller 150 may control various operations related to typical functions of the folding device 100. For example, when an application is executed, the controller 150 may control at least one of the first display unit 120 and the second display unit 130 to display operation and data associated with the application. The controller 150 may receive various input signals corresponding to various inputting methods supported by a touch-based input interface and may control a functional management according to the received signals. The controller 150 may control supplementary functions of processing of transmission and reception (for example, message reception and transmission) of data generated when an internet service such as SNS that is supported through wireless LAN or mobile communication, or tracking and grouping the transmitted and received data, and or outputting the grouped data on a popup menu on one of the first display unit 120 and the second display unit 130.

Although the invention has been described with regard to a folding device 100 of FIG. 1, it would be understood that the principles of the invention described may be applied to other types of devices such as a bar type device having a hinge to which the multi-functional peripheral device 200 is connected or an element corresponding to a hinge, a folder type device, a slide type device, a swing type device, and a flip type device. The folding device 100 may represent different types of I information communication devices, a multimedia device, and an application thereof, to which the multi-functional peripheral device 200 may connected through a connection similar to that shown as the connection unit 350 and the connection unit 250. For example, the folding device 100 may include a mobile communication terminal operated under the communication protocols corresponding to various communication systems, a tablet PC, a portable multimedia player (PMP), a digital broadcasting player, a personal digital assistant (PDA), a portable game terminal, a netbook, a laptop computer, and a smart phone.

On the other hand, elements of the multi-functional peripheral device 200 according to the exemplary embodiment of the present invention may correspond to respective elements of the folding device 100. For example, the multi-functional peripheral device 200 may include a communication module, a display unit, a storage unit, a second connection unit, and a controller. (see FIG. 6). Operations of the elements of the multi-functional peripheral device 200, as described above, correspond to the operations of the respective elements of the folding device 100 or the later-described operations of the multi-functional peripheral device 200, and thus the description of the elements of the multi-functional peripheral device 200 will be omitted so as not to repeat the functions of elements that have already been described.

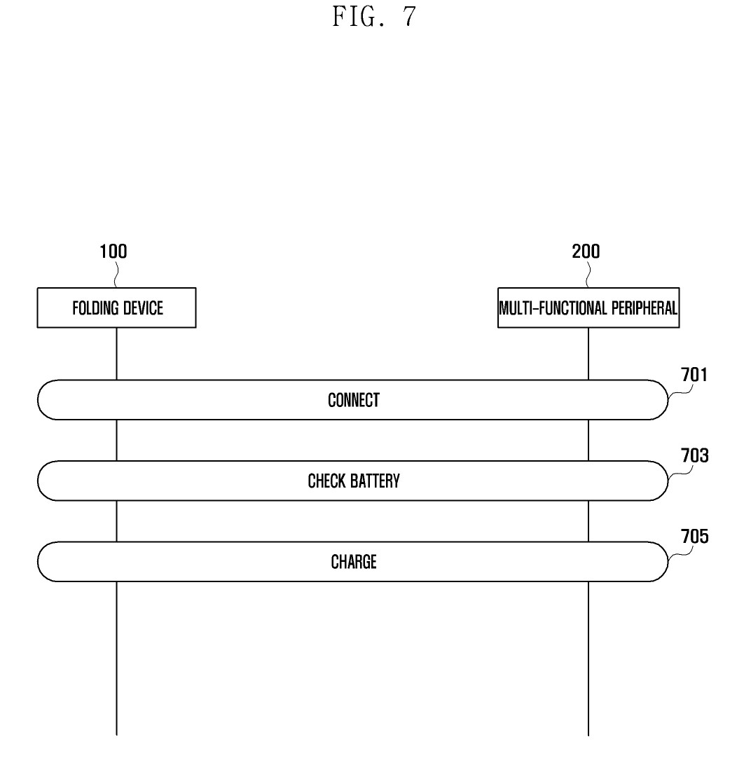

FIG. 7 is a view schematically illustrating a charging operation between the folding device 100 and the multi-functional peripheral device 200 according to an exemplary embodiment of the present invention.

Referring to FIG. 7, the folding device 100 and the multi-functional peripheral device 200 are physically connected to each other through the first connection unit 350 and the second connection unit 250 as described above (Step 701). That is, the multi-functional peripheral device 200 is attached to folding device 100; as previously describe, and the attachment may be through the hinge element of the folding device 100 to present a conformal configuration for folding device 100.

Next, when the multi-functional peripheral device 200 is connected, the folding device 100 may check a battery status (Step 703). In this case, the folding device 100 may check whether a battery (hereinafter, referred to as an ‘external battery’) of the multi-functional peripheral device 200 is in a fully-charged state (or equal to or higher than a first preset reference level, for example 70%) by checking a voltage of the external battery. The folding device 100 may check whether a battery (hereinafter, referred to as an “internal battery”) in the folding device 100 equal to or higher than a second preset reference level (for example, higher than 50% of overall capacity of the internal battery) by checking a voltage of the internal battery when the external battery of the multi-functional peripheral device 200 is less than the first preset reference level.

Next, the folding device 100 may supply electrical energy to the multi-functional peripheral device 200 when it is determined that the external battery of the multi-functional peripheral device 200 is below the first preset reference level (Step 705). For example, when the condition (e.g., voltage or battery capacity) external battery of the multi-functional peripheral device 200 is lower than the first preset reference level (or not at the fully charged state when comparing the fully charged state), the remaining capacity of the internal battery of the folding device 100 may be checked. When the remaining capacity of the internal battery is higher than the second preset reference level, the folding device 100 may charge the external battery of the multi-functional peripheral device 200. However, when the remaining capacity of the internal battery is less than the second preset reference level, the folding device 100 may stop or not start the charging of the multi-functional peripheral device 200 and provide an indication (i.e., a feedback) of status of at least the internal battery, and possibly of the external battery, to a user. Here, the feedback may be serviced by one of the folding device 100 and the multi-functional peripheral device 200 via at least one of a sound, a vibration, and a display of information.

However, if charging is taking place, then the folding device 100 may continuously check the status of the internal battery during the charging of the multi-functional peripheral device 200 and stop the charging of the multi-functional peripheral device 200 when the remaining capacity of the internal battery is less than the second preset reference level or when the external battery is indicated to be at full charge. When the charging is stopped, information regarding the stopping of the charging (i.e., charge complete, battery full) may be provided to the user.

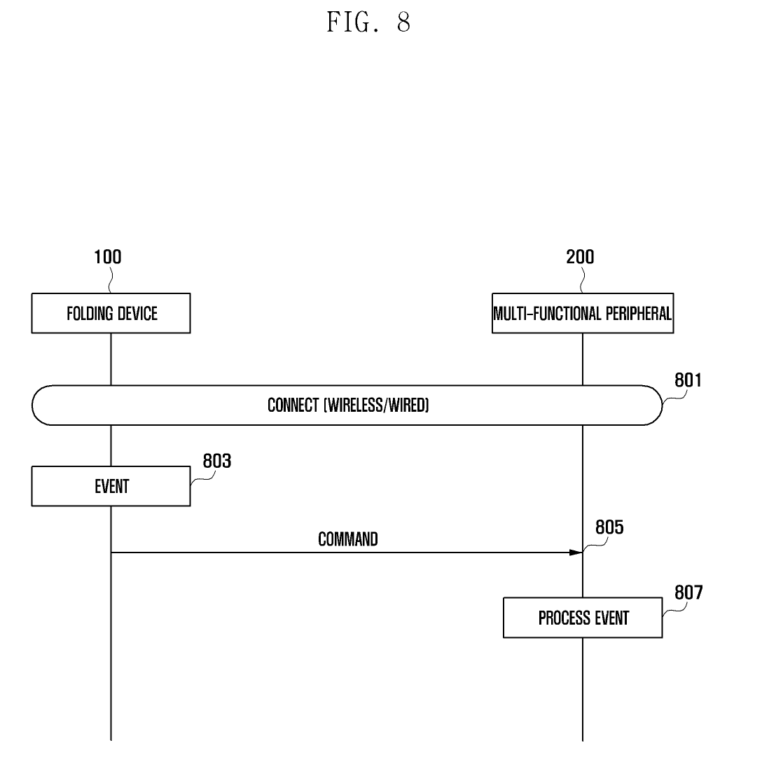

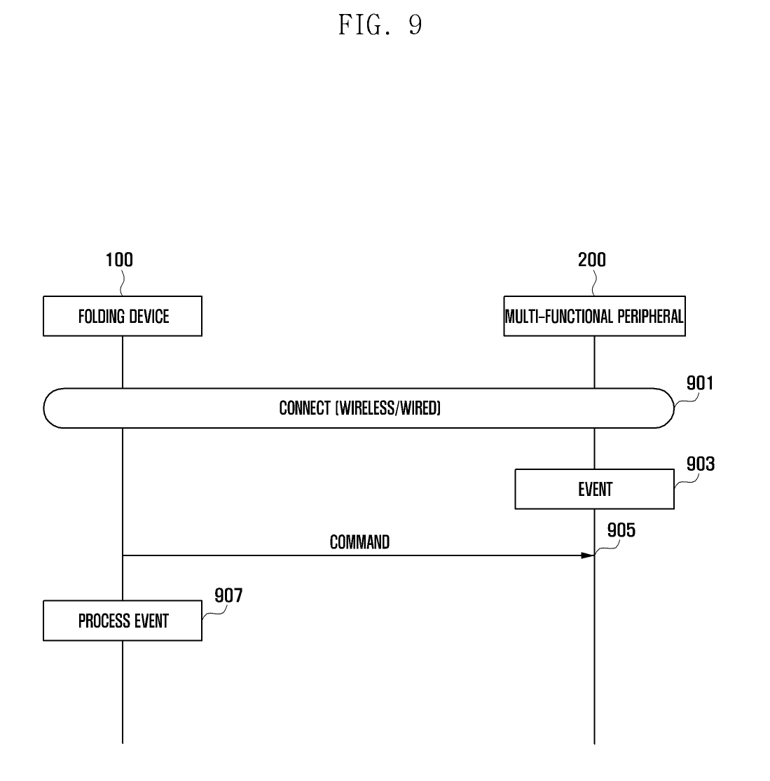

FIGS. 8 and 9 schematically illustrate event processing between the folding device 100 and the multi-functional peripheral device 200 according to an exemplary embodiment of the present invention. FIG. 8 shows an operation in which the folding device 100 transmits commands to the multi-functional peripheral device 200 according to an event (hereinafter, referred to as an “internal event”) generated in the folding device 100. FIG. 9 shows an operation in which the multi-functional peripheral device 200 transmits commands to the folding device 100 according to an event (hereinafter, referred to as an “external event”) generated in the multi-functional peripheral device 200.

Referring to FIG. 8, the multi-functional peripheral device 200 may be attached to, or detached from, the folding device 100 and in either case, the folding device 100 and the multi-functional peripheral device 200 may be interconnected with each other (Step 801), either physically or wirelessly. That is, when the multi-functional peripheral device 200 is attached to the folding device 100, the multi-functional peripheral device 200 and the folding device 100 may be connected to each other through wired communication based on the connection between the first connection unit 350 and the second connection unit 250. Otherwise, when the multi-functional peripheral device 200 is detached from the folding device 100, the folding device 100 and the multi-functional peripheral device 200 may be connected to each other through radio communication based on a supportable wireless communication protocol. For example, the folding device 100 and the multi-functional peripheral device 200 may be connected to each other by a near field wireless communication, as previously described. In FIG. 8, it is assumed that the folding device 100 is in the closed state. That is, FIG. 8 may show the folding device 100 connected to the multi-functional peripheral device 200 in the closed state via wireless line (e.g., illustration 1 b of FIG. 1) or wired (e.g., illustration 1a of FIG. 1) line.

Next, when the illustrated internal event occurs at the connection with the multi-functional peripheral device 200 (Step 803), the folding device 100 may transmit commands corresponding to the internal event to the multi-functional peripheral device 200 (Step 805). For example, when a preset message is received from the outside when in the closed state, the folding device 100 may generate event information about the received message and transmit the generated event information and a command for outputting the event information (for example, screen output, sound output, etc.) to the multi-functional peripheral device 200. The event occurring in the folding device 100 may include receipt of a message from a messenger service such as SNS, RSS, SMS, and MMS, an information event generated by the message service, a sound event generated by reproducing a media, and/or a call event generated when a call is received. Thus, the invention provides information that corresponds to the event and that may be outputted and the command is to instruct the output corresponding to the event.

Next, when a command is received by the multi-functional peripheral device 200, the multi-functional peripheral device 200 may process the event (Step 807). For example, when a command corresponding to an event related to the reception of a message is received, the multi-functional peripheral device 200 may process the event information related to the received command reception. For example, at least one of the screen displaying and the sound output may be activated in response to the received command. That is, the multi-functional peripheral device 200 may process the output of the event information corresponding to the event in response to the command.

Referring to FIG. 9, the multi-functional peripheral device 200 may be attached to, or detached from, the folding device 100 and the folding device 100 and the multi-functional peripheral device 200 may be connected to each other at any one of a wired or a wireless state (Step 901). In this case, when the multi-functional peripheral device 200 is attached to the folding device 100, the folding device 100 and the multi-functional peripheral device 200 may be connected through the connection between the first connection unit 350 and the second connection unit 250. Otherwise, when the multi-functional peripheral device 200 is detached from the folding device 100, the folding device 100 and the multi-functional peripheral device 200 may be interconnected through a supported communication protocol. In FIG. 9, it is assumed that the folding device 100 is in the closed state or in the open state. That is, FIG. 9 may show the folding device 100 connected to the multi-functional peripheral device 200 in the closed state or in the open state via wireless line or wired line.

Next, when the external event occurs in the case that the multi-functional peripheral device 200 is connected to the folding device 100 as previously described(Step 903), the multi-functional peripheral device 200 may transmit a command corresponding to the event to the folding device 100 (Step 905). For example, when the event is generated by a touch input-based interface (for example, a display unit), a preset button, or a microphone, the multi-functional peripheral device 200 may transmit a command requesting control of the event to the folding device 100. In the present invention, the event may be generated in the multi-functional peripheral device 200 by an external input by a user and the multi-functional peripheral device 200 may transmit the command corresponding to the event. The command by the multi-functional peripheral device 200 may include a command for functional control of media that is being played by the folding device 100 (for example, volume up/down, fast winding, rewinding, jumping, movement/search play list, channel change, etc.) or a command corresponding to a voice signal transmitted from the microphone.

When a command is received from the multi-functional peripheral device 200, the folding device 100 may process an event (Step 907). For example, when a command corresponding to a functional control of media that is being played is received, the folding device 100 may change the functional control. When a command corresponding to a voice signal is received while a call is connected, the folding device 100 may transmit the voice signal to the other party device to which the call is connected.

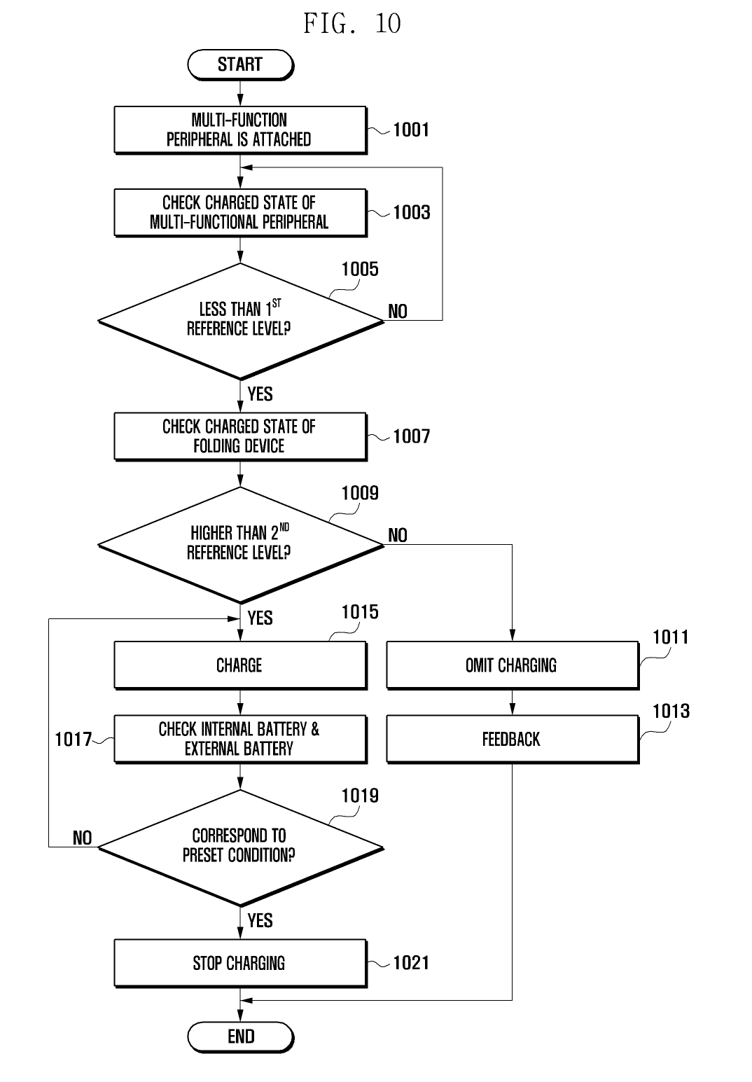

FIG. 10 is a flowchart illustrating a method of charging a multi-functional peripheral device 200 by the folding device 100 according to an exemplary embodiment of the present invention.

Referring to FIG. 10, it is assumed that the multi-functional peripheral device 200 is attached to the folding device 100 (Step 1001). At this state, the controller 150 of the folding device 100 may check the charged state of the multi-functional peripheral device 200 (Step 1003). For example, the controller 150 may check a voltage level of a battery (hereinafter, referred to as an ‘external battery’) of the multi-functional peripheral device 200 that is transmitted through the first connection unit 350 of the folding device 100 and the second connection unit 250 of the multi-functional peripheral device 200 by measuring voltage of the external battery. That is, the controller 150 may check the charged state of the external battery. The checking of the external battery may be performed periodically according to a preset period when the multi-functional peripheral device 200 is attached to the folding device 100.

Next, the controller 150 may determine whether the external battery is less than a first reference level (Step 1005). That is, the controller 150 may compare a voltage level of the external battery with the first reference level (e.g., a threshold voltage value or a remaining capacity) and determine whether the charged state of the external battery is less than or higher than the first reference level. In this exemplary embodiment, the first reference level may be set in advance to determine whether the battery (that is, the external battery) of the multi-functional peripheral device 200 is charged, or may be set in advance when the folding device 100 is manufactured, or may be changed into another value by a user. For example, the first reference level may be set to values wherein the remaining capacity (or voltage) of the external battery, may be set, for example, to 90%, 50%, or 10%, etc. of the overall capacity of the external battery.

The controller 150 may proceed to the Step 1003 when the external battery is charged to a value that is higher than the first reference level (‘NO’ of Step 1005) and may perform the charged state check of the external battery and another operation according to the preset period.

The controller 150 may check the charged state of the folding device 100 when the external battery is charged less than the first reference level (‘YES’ of Step 1005). For example, the controller 150 may check a voltage level (or a remaining capacity) of a battery (hereinafter, referred to as an ‘internal battery’) of the folding device 100 by measuring a voltage (or a remaining capacity) of the internal battery. In the present invention, the checking of the internal battery may be performed when the charging of the external battery is determined to be needed.

The controller 150 may determine whether the internal battery is charged to a value higher than a second reference level (e.g., a second threshold value) (Step 1009). That is, the controller 150 may determine whether the charged state of the internal battery is higher or less than the second reference level by comparing a voltage level (or a remaining capacity) of the internal battery with the second reference level. In this exemplary embodiment, the second reference level is set to determine whether the battery of the multi-functional peripheral device 200 (that is, the external battery) is to be charged by considering the remaining capacity of the battery of the folding device 100. The second reference value may be set in advance when the folding device 100 is manufactured, or may be changed to another value by a user. For example, the second reference level may be set to a value corresponding to 90%, 50%, or 10%, etc. of the overall capacity or the voltage of the internal battery. The second reference level may be set by considering usefulness of the folding device 100.

The controller 150 may skip (omit) the charging of the multi-functional peripheral device 200 (Step 1011) and may provide feedback information that the charge on the internal battery less than the second reference level (‘NO’ of Step 1009) and battery of the connected device is not being charged. For example, when the remaining capacity of the internal battery is less than the second reference level, the controller 150 may skip the charging of the external battery. The controller 150 may provide feedback that the charging of the external battery is not being performed due to limited remaining capacity of the internal battery. In this case, the controller 150 may provide a feedback by outputting at least one of a sound, a vibration, and an information display through one or both of the folding device 100 and the multi-functional peripheral device 200 (Step 1013).

When the remaining capacity (or voltage) of the internal battery is higher than the second reference level (‘YES’ of Step 1009), the controller 150 may perform the charging of the multi-functional peripheral device 200 (Step 1015). For example, the remaining capacity of the internal battery is higher than the second reference level, the controller 150 may control the charging of the external battery by supplying electric power to the multi-functional peripheral device 200 through the first connection unit 350 and the second connection unit 250.

The controller 150 may continuously check the status of the internal battery and the external battery during the charging of the external battery (Step 1017). The controller 150 may determine whether one of the internal battery and the external battery fails below or remains above the corresponding threshold value or reference value by checking the internal battery and the external battery (Step 1019). For example, the controller may determine whether the remaining capacity of the internal battery is less than the second reference level or whether the remaining capacity of the external battery is higher than a third reference level (i.e., a third threshold), during the charging the external battery. In this exemplary embodiment, the third reference level may be set to a value that determines whether the charging of the external battery is to stop when the external battery is charged higher than the third threshold value. The value of the third reference level may be set similar to that of the first reference level or another value according to a managing method (manufacturer, user).

When the charge of the internal battery remains above the second threshold and the charge of the external battery is below the third threshold, (‘NO’ of Step 1019), the controller 150 may proceed to the step 1015 and may perform the charging of the external batterys.

When the charge of the internal battery falls below the second reference level or charge of the external battery exceeds the third threshold value, (‘YES’ of Step 1019), the controller 150 may stop the charging of the external battery (Step 1021). For example, when the remaining capacity of the internal battery is less than the second reference level during the charging of the external battery while supplying electric power using the internal battery, the controller 150 may turn off a connecting channel for the charging of the external battery to stop the charging of the external battery. Otherwise, when the remaining capacity of the internal battery is higher than the third reference level during the charging process, the controller 150 may turn off the connecting channel for the charging of the external battery to stop the charging of the external battery.

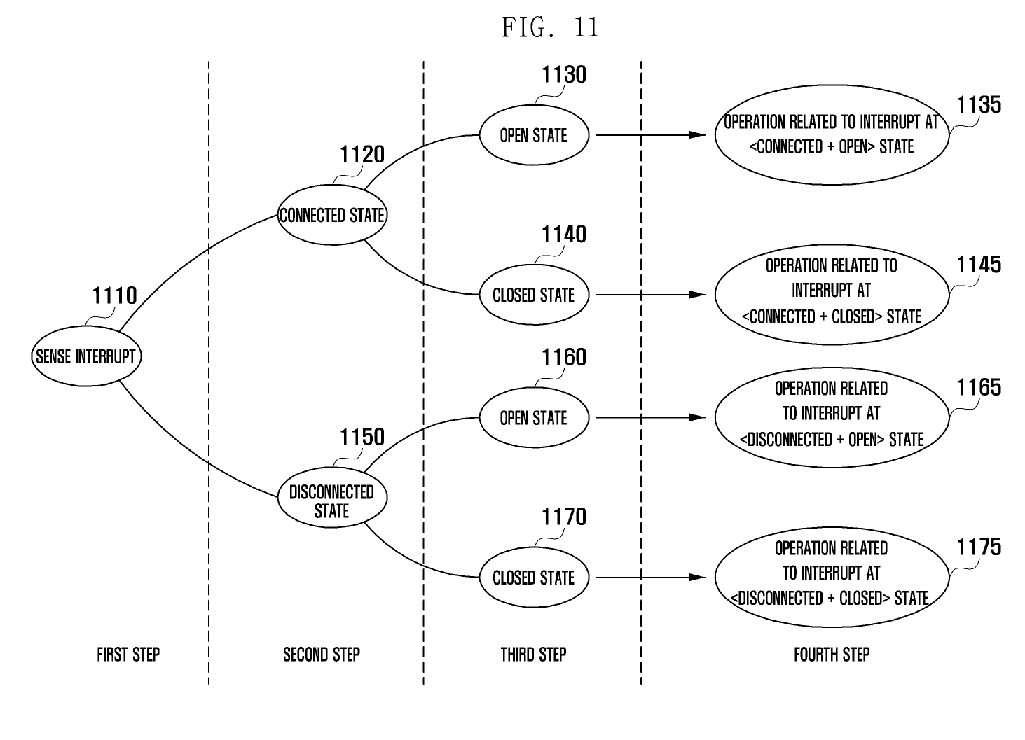

FIG. 11 illustrates operations managed by interconnection between a folding device 100 and a multi-functional peripheral device 200 according to an exemplary embodiment of the present invention.

As illustrated in FIG. 11, operation caused by the connection between the folding device 100 and the multi-functional peripheral device 200 may be roughly divided into four steps. For example, the four steps are a first step of sensing an interrupt, a second step of checking a connected or disconnected state of the multi-functional peripheral device 200, a third step of checking an open or closed state of the folding device 100, and a fourth step of processing functional management corresponding to the connected/disconnected state of the multi-functional peripheral device 200 and the open/closed state of the folding device 100. In this illustrative process, the second step of checking the connected/disconnected state and the third step of checking the open/closed state need not performed in the above order. The second step of checking the connected/disconnected state may be performed after the third step of checking the open/closed state is performed.

Referring to FIG. 11 again, as indicated by reference numeral 1110, the controller 150 of the folding device 100 may sense an interrupt generated from the folding device 100. Here, the interrupt may be internal interrupt generated from the folding device 100 or an external interrupt that is generated and transmitted from the multi-functional peripheral device 200. In this exemplary embodiment, the internal interrupt, as described above, indicates an interrupt generated from the folding device 100 and may include an interrupt caused by reception of information related to services such as SNS, RSS, SMS, MMS, e-mail, or a call function, or by media reproduction. The external interrupt, as described above, indicates an interrupt that is generated and transmitted from the multi-functional peripheral device 200 and may include an interrupt caused by reception of a voice signal when a call function is executed, an interrupt by reception of a control signal for media reproduction, or an interrupt by a request signal for confirm of information such as SNS, RSS, SMS, MMS, e-mail, etc.

The controller 150, as indicated by reference numerals 1120 and 1150, may determine when the multi-functional peripheral device 200 is in a connected state or a disconnected state when the internal interrupt or the external interrupt is sensed. That is, the controller 150 may distinguish whether the multi-functional peripheral device 200 is mounted to, or separated from, the connection 350 with the folding device 100. In this case, the controller 150 may determine by checking the connected state between the first connection unit 350 and the second connection unit 250.

After determination for the connected state or the disconnected state of the multi-functional peripheral device 200, the controller 150, as indicated by reference numerals 1130, 1140, 1160, and 1170, may determine when the folding device 100 is in an open state or a closed state. For example, the controller 150 may check whether the folding device 100 is in the closed state or in the open state as indicated by reference numerals 1130 and 1140. Similarly, the controller 150, when the multi-functional peripheral device 200 is in the disconnected state, may check whether the folding device 100 is in the open state or the closed state as indicated by reference numerals 1160 and 1170.

The controller 150, as described above, may control operation related to the interrupt at a corresponding state as indicated by reference numerals 1135, 1145, 1165, and 1175 after checking whether the multi-functional peripheral device 200 is connected or disconnected and whether the folding device 100 is opened or closed.

The controller 150 may process an operation related to an interrupt indicated by reference numeral 1110 when the multi-functional peripheral device 200 is connected as indicated by reference numeral 1120 and when the folding device 100 is opened as indicated by reference numeral 1130, that is, in a <Connected+Open> state. For example, the controller 150 may control at least one of the first display unit 120 and the second display unit 130 of the folding device 100 to display data corresponding to the interrupt. In this case, the controller 150 may omit transmission of a command to the multi-functional peripheral device 200. In this exemplary embodiment, since the multi-functional peripheral device 200 are not frequently used at the <Connected+Open> state, only the operation 1135 for the folding device 100 may be performed.

Moreover, the controller 150 may process an operation for the interrupt as indicated by reference numeral 1110 when the multi-functional peripheral device 200 is connected as indicated by reference numeral 1120 and when the folding device 100 is closed as indicated by reference numeral 1140, that is, at a <Connected+Closed> state. For example, the controller 150 may transmit a command for reception of a message from the outside to the multi-functional peripheral device 200. In this case, the controller 150 may omit functional control of the folding device 100. In this exemplary embodiment, since the folding device 100 is not frequently used when in the <Connected+Closed> state, information for the interrupt may be fed back through the multi-functional peripheral device 200.

Moreover, the controller 150 may process functional operation for an interrupt as indicated by reference numeral 1110 when the multi-functional peripheral device 200 is disconnected as indicated by reference numeral 1150 and when the folding device 100 is opened, that is a <Disconnected+Open> state. For example, the controller 150 may control at least one of the first display unit 120 and the second display unit 130 of the folding device 100, for reproducing media or to display data corresponding to the interrupt. In this case, the controller 150 may omit the transmission of a command to the multi-functional peripheral device 200. Otherwise, the controller 150 may transmit a voice signal received from the multi-functional peripheral device 200, according to the call function, to another party device by operating the folding device 100. In this case, the controller 150 may transmit a command on the reception of the voice signal from the device of the other party to the multi-functional peripheral device 200. In the <Disconnected+Open> state, the multi-functional peripheral device 200 may serve as a wireless headset when the call function is executed or as a remote controller for controlling functions related to a media reproduction (for example, playing of a moving picture, playing of a music file, displaying of an e-book, etc.) remotely.

In addition, the controller 150 may process functional operations for the interrupt as indicated by reference numeral 1110 when the multi-functional peripheral device 200 is disconnected as indicated by reference numeral 1150 and when the folding device 100 is closed as indicated by reference numeral 1170, that is, at a <Disconnected+Closed> state. For example, the controller 150 may transmit a command for a message reception to the multi-functional peripheral device 200. In this case, the controller 150 may omit the functional control of the folding device 100. Otherwise, the controller 150 may transmit a voice signal received from the multi-functional peripheral device 200 by the call function to another party device by operating the folding device 100. For example, when an interrupt is received indicating a call is being received, then the folding device may be operated to present the display units to the user. In this case, the controller 150 may transmit a command for reception of the voice signal from the other party's device to the multi-functional peripheral device 200. Otherwise, the controller 150 may transmit a command corresponding to playing a media by the folding device 100 to the multi-functional peripheral device 200. In this exemplary embodiment, the multi-functional peripheral device 200 may serve as a wireless headset when the call function is executed, or as a remote controller for controlling functions related to media reproduction (for example, playing of a music file) remotely, or as a unit for receiving and outputting information corresponding to services such as SNS, RSS, SMS, MMS, e-mail, etc.

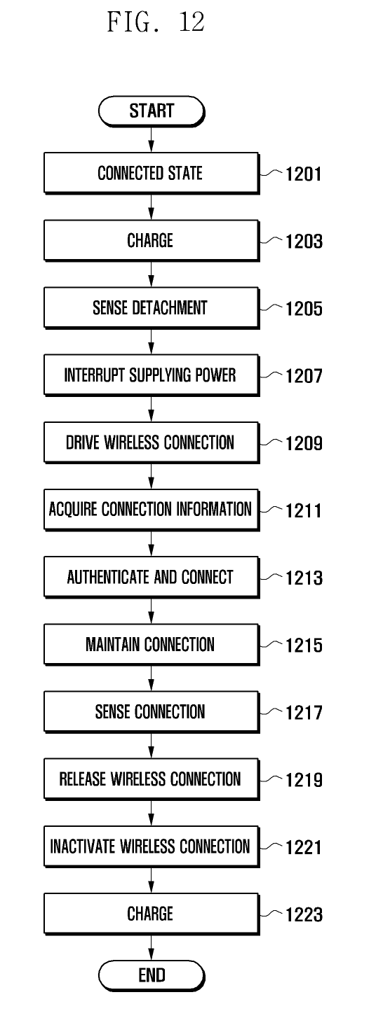

FIG. 12 is a flowchart illustrating a managing method corresponding to attachment and detachment of the multi-functional peripheral device 200 to, and from, the folding device 100 according to an exemplary embodiment of the present invention.

Referring to FIG. 12, in a state when the multi-functional peripheral device 200 is connected to the folding device 100 (Step 1201), the controller 150 may control the charging of the multi-functional peripheral device 200 by supplying electric power (Step 1201), as previously described. For example, when the folding device 100 and the multi-functional peripheral device 200 are connected to each other through corresponding connection units on the hinge, the controller 150 checks the battery of the multi-functional peripheral device 200 and the battery of the folding device 100 as described above. When a voltage level of the battery of the multi-functional peripheral device 200 is less than the first reference level and a voltage level of the folding device 100 is higher than the second reference level, the controller may control the charging of the multi-functional peripheral device 200.

The controller 150 may sense the detachment of the multi-functional peripheral device 200 (Step 1205). For example, when there is a state change from the connected state of the multi-functional peripheral device 200 into the disconnected state, the controller 150 may sense the multi-functional peripheral device 200 as being detached. That is, the multi-functional peripheral device 200 may have been detached from the attached hinge of the folding device 100 by a user.

The controller 150 may stop supplying electric power to the multi-functional peripheral device 200 when the detachment of the multi-functional peripheral device 200 is sensed (Step 1207). That is, the controller 150 may stop charging the battery of the multi-functional peripheral device 200 when detachment is sensed. When the charging of the multi-functional peripheral device 200 is not being performed the step 1207 may be omitted.

The controller 150 may drive the wireless connection when the detachment of the multi-functional peripheral device 200 is sensed (Step 1209). For example, the controller 150 may drive the communication module 110 for near field wireless communication with the multi-functional peripheral device 200, when detachment is sensed.

The controller 150 may acquire connection information set for the wireless connection with the multi-functional peripheral device 200 (Step 1211). For example, identification information of the multi-functional peripheral device 200 (for example, device address) may be acquired from the storage unit 140. The controller 150 may control an automatic authentication function and connection for the multi-functional peripheral device 200 based on the connection information (Step 1213). For example, the controller 150 may control auto-pairing of a Bluetooth communication connection. After that, the controller 150 may maintain the wireless connection with the multi-functional peripheral device 200 (Step 1215).

The controller 150 may sense connection with the multi-functional peripheral device 200 (Step 1217) while maintaining the wireless connection (Step 1215). For example, the controller 150 may sense the multi-functional peripheral device 200 is attached when the disconnected state of the multi-functional peripheral device 200 is changed into the connected state. That is, the multi-functional peripheral device 200 that is detached may be attached by a user to the hinge of the folding device 100 during a call or a playback function.

In this case, the controller 150 may disconnect the wireless connection that is established when the connection of the multi-functional peripheral device 200 is sensed (Step 1219). The controller 150 may inactivate the previously established wireless connection (Step 1221). For example, the controller 150 may inactivate the communication module driven for the wireless connection with the multi-functional peripheral device 200.

The controller 150 may then initiate a process that controls the charging of the multi-functional peripheral device 200, as described above (Step 1223).

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

The exemplary embodiments of the present invention are provided for the understanding of the present invention with specific examples but do not limit the scope of the present invention. It will be appreciated by those skilled in the art that various changes and modifications may be practiced without departing from the spirit of the present invention.

What is claimed is:

1. A method, operable in a controller, for operating a folding device comprising an attachable multi-functional peripheral device, the method comprising causing the controller to perform the steps of:
sensing an interrupt;
checking a state of the multi-functional peripheral device with respect to the folding device, wherein the state is one of: a connected state and a disconnected:
checking a state of the folding device, the state of the folding device being one of: an open state and a closed state; and
controlling a functional operation related to the interrupt according to the multi-functional peripheral device and the folding device.

2. The method of claim 1, wherein the checking of the state of the multi-functional peripheral device comprises the step of:
checking a connection between a first connection unit provided to a hinge of the folding device and a second connection unit of the multi-functional peripheral device.

3. The method of claim 2, further comprising the step of controlling charging of the multi-functional peripheral device according to a given condition when the multi-functional peripheral device is connected to the folding device

4. The method of claim 3, wherein the controlling of the charging comprises the steps of:
checking a state of a battery of the multi-functional peripheral device;
checking a state of a battery of the folding device when the state of the battery of the multi-functional peripheral device is less than a first reference level; and
controlling the charging of the multi-functional peripheral device by supplying electric power from the battery of the folding device when the state of the battery of the folding device is higher than a second reference level.

5. The method of claim 4, further comprising the step of:
stopping the charging when one of: the state of the battery of the multi-functional peripheral device is higher than a third reference level and when the state of the battery of the folding device is less than the second reference level is determined.

6. The method of claim 5, further comprising the step of stopping the charging when a state of the multi-functional peripheral device is changed from a connected state into a disconnected state.

7. The method of claim 6, further comprising the step of controlling an automatic wireless connection with the multi-functional peripheral device when the multi-functional peripheral device is changed from the connected state into the disconnected state.

8. A folding device including an attachable multi-functional peripheral device, the folding device comprising:
a first connection unit connected to a second connection unit of the multi-functional peripheral device; and
a controller for:
controlling charging of the multi-functional peripheral device according device to a given condition when the folding device and the multi-functional peripheral device are in a connected state through the first connection unit being connected to the second connection unit of the multi-functional peripheral device, and
establishing a wireless connection with the multi-functional peripheral device when the folding device and the multi-functional peripheral device are in a disconnected state when the multi-functional device is disconnected from the second connection unit

9. The folding device of claim 8, wherein the controller controls a functional operation for a sensed preset interrupt according to the connected state or the disconnected state of the multi-functional peripheral device and an open state or a closed state of the folding device.

10. The folding device of claim 9, wherein the controller controls charging of the multi-functional peripheral device by supplying electric power when a state of a battery of the multi-functional peripheral device is less than a first reference level and a state of a battery of the folding device is higher than a second reference level.

11. The folding device of claim 10, wherein the controller stops charging the battery of the multi-functional peripheral device when one of: the state of the battery of the multi-functional peripheral device is higher than a third reference level and the state of the battery of the folding device is less than the second reference level.

12. The folding device of claim 10, wherein the controller stops the charging when the state of the multi-functional peripheral device is changed from the connected state into the disconnected state.

13. The folding device of claim 10, wherein the controller controls an automatic wireless connection with the multi-functional peripheral device when the state of the multi-functional peripheral device is changed from the connected state into the disconnected state.

14. The folding device of claim 10, wherein the first connection unit is provided in the hinge of the folding device and the first connection unit is connected to the second connection unit through the hinge.

15. A device comprising:
a multi-functional peripheral device, and
a folding device:
supporting an attachable hinge, wherein the multi-functional peripheral device is removably attachable to the attachable hinge;
performing charging of the multi-functional peripheral device when the multi-functional peripheral device is in a connected state to the folding device through the hinge, and
performing wireless connection of the multi-functional peripheral device when the multi-functional peripheral device is at a disconnected state.

16. A portable terminal comprising:
a first display element enclosed within a first enclosure; and
a second enclosure, opposing the first enclosure, and
a hinge joining said first and second enclosures partially along an edge of each of the first and second enclosures, the hinge further comprising;
an electrical connection for removably connecting a peripheral device along the edge of the first and second enclosures, and
a processor in communication with a memory, the memory including code which when accessed by the processor causes the processor to:
determine whether the peripheral device is connected to the electrical connector;
determine whether the first and second enclosures are in one of: an open and closed state; and
perform at least one operation based on whether the first and second enclosures are in one of: an open and a closed state, and whether the peripheral device is connected to the electrical connector along the edge of the first and second enclosure.

17. The portable terminal of claim 16, further comprising:
a communication unit, said communication unit being activated when the peripheral device is not connected.

18. The portable terminal of claim 16; wherein the processor, in response to an indication of connection of the peripheral device;
determines a condition of a battery associated with the peripheral device;
determines a condition of a battery of the portable terminal; and directs electrical energy from the battery associated with the portable terminal to the battery associated with the battery of the peripheral device, when the condition of the battery of the portable terminal is greater than a second predetermined value and the condition of the battery of the peripheral device is less than a first predetermined value.

19. The portable terminal of claim 18, wherein electrical energy from the battery associated with the portable terminal is removed from the battery of the peripheral device when one of: the condition of the battery of the portable terminal is less than the second predetermined value and the condition of the battery of the peripheral device is greater than a third predetermined value.

20. The portable terminal of claim 19, wherein the first predetermined value and the third predetermined value are the same.
